(19) United States
(12) Patent Application Publication
(10) Pub. No.: US 2022/0128376 A1
(43) Pub. Date: Apr. 28, 2022

(54) INFORMATION PROCESSING DEVICE, INFORMATION PROCESSING METHOD, AND SYSTEM

(71) Applicant: TOYOTA JIDOSHA KABUSHIKI KAISHA, Toyota-shi (JP)

(72) Inventors: Shuichi SAWADA, Nagoya-shi (JP); Mitsuhiro MIURA, Okazaki-shi (JP); Yusuke NAKADE, Nagoya-shi (JP); Shin SAKURADA, Toyota-shi (JP); Ai MIYATA, Okazaki-shi (JP); Satoshi KOMAMINE, Nagoya-shi (JP)

(73) Assignee: TOYOTA JIDOSHA KABUSHIKI KAISHA, Toyota-shi (JP)

(21) Appl. No.: 17/511,038

(22) Filed: Oct. 26, 2021

(30) Foreign Application Priority Data
Oct. 26, 2020 (JP) 2020-178955

(51) Int. Cl. G01C 21/36

(52) U.S. Cl. CPC G01C 21/3641; G01C 21/3667; G01C 21/3617

(57) ABSTRACT

A controller comprising at least one processor in an information processing device obtains a travel route to a destination of a user and identifies a plurality of digital signs that exist on the travel route and guide the user to the destination. In addition, the controller in the information processing device transmits first information to a first sign included in the plurality of digital signs, the first information being information for guiding the user to a second sign, the second sign being a digital sign guiding the user to the destination subsequently to the first sign on the travel route.

### CROSS REFERENCE TO THE RELATED APPLICATION

This application claims the benefit of Japanese Patent Application No. 2020-178955, filed on Oct. 26, 2020, which is hereby incorporated by reference herein in its entirety.

### BACKGROUND

### Technical Field

The present disclosure relates to an information processing device, an information processing method, and a system.

### Description of the Related Art

Japanese Patent Laid-Open No. 2007-48132 discloses a visitor guidance system of a large-scale facility such as an airport. The visitor guidance system disclosed in the patent literature recognizes location information on an e-tag and e-tag information stored in the e-tag, obtains information on a relation between the recognized location information and the e-tag information from a server via a communication line, and displays a guide, based on the obtained relation information.

### SUMMARY

An object of the present disclosure is to guide a user to a destination.

An information processing device according to a first aspect of the present disclosure includes a controller comprising at least one processor. The controller executes: obtaining a travel route to a destination of a user; identifying a plurality of digital signs that exist on the travel route and guide the user to the destination; and transmitting first information to a first sign included in the plurality of digital sign, the first information being information for guiding the user to a second sign, the second sign being a digital sign guiding the user to the destination subsequently to the first sign on the travel route.

An information processing method according to a second aspect of the present disclosure is an information processing method executed by a computer. The information processing method includes: obtaining a travel route to a destination of a user; identifying a plurality of digital signs that exist on the travel route and guide the user to the destination; and transmitting first information to a first sign included in the plurality of digital sign, the first information being information for guiding the user to a second sign, the second sign being a digital sign guiding the user to the destination subsequently to the first sign on the travel route.

A system according to a third aspect of the present disclosure is a system that includes an information processing device and a plurality of digital signs. The information processing device obtains a travel route to a destination of a user, identifies a plurality of digital signs that exist on the travel route and guide the user to the destination, and generates first information for a first sign included in the plurality of digital signs, the first information being information for guiding the user to a second sign, the second sign being a digital sign guiding the user to the destination subsequently to the first sign on the travel route. The plurality of digital signs receive the first information from the information processing device.

The present disclosure allows a user to be guided to a destination.

### BRIEF DESCRIPTION OF THE DRAWINGS

FIG. 1 is a diagram illustrating a schematic configuration of a guidance system according to a first embodiment;

FIG. 2 is a diagram illustrating a part of a predetermined area;

FIG. 3 is a block diagram schematically illustrating an example of a functional configuration of each of a digital sign and a management server;

FIG. 4 is a diagram illustrating an example of a table configuration of guidance information;

FIG. 5 is a first sequence diagram illustrating information and process flows in the guidance system according to the first embodiment;

FIG. 6 is a flowchart of display instruction processing;

FIG. 7 is a diagram illustrating a schematic configuration of a guidance system 2 according to a second embodiment;

FIG. 8 is a block diagram schematically illustrating an example of a functional configuration of each of a digital sign, a management server, and a user terminal; and

FIG. 9 is a second sequence diagram illustrating information and process flows in the guidance system according to the second embodiment.

### DESCRIPTION OF THE EMBODIMENTS

An information processing device according to a first aspect of the present disclosure is an information processing device that manages digital signs. A controller comprising at least one processor in the information processing device according to the first aspect of the present disclosure obtains a travel route to a destination of a user. In addition, the controller in the information processing device identifies a plurality of digital signs that exist on the travel route. Each of the digital signs here is a digital sign that guides the user to the destination. Furthermore, the controller transmits first information to a first sign included in the plurality of digital signs. The first information here is information for guiding the user to a second sign that is a digital sign guiding the user to the destination subsequently to the first sign on the travel route.

The first sign guides the user to the second sign based on the first information received from the information processing device. The user who has traveled to the second sign is then guided to the destination by the second digital sign. As described above, the information processing device makes the first sign and the second sign coordinated with each other, thereby allowing the user to be guided to the destination.

Hereinafter, specific embodiments of the present disclosure will be described with reference to drawings. The dimensions, materials, shapes, relative arrangements and the like of the components described in these embodiments are not intended to limit a technical scope of the present disclosure thereto unless otherwise stated.

### <First Embodiment>

### (System Overview)

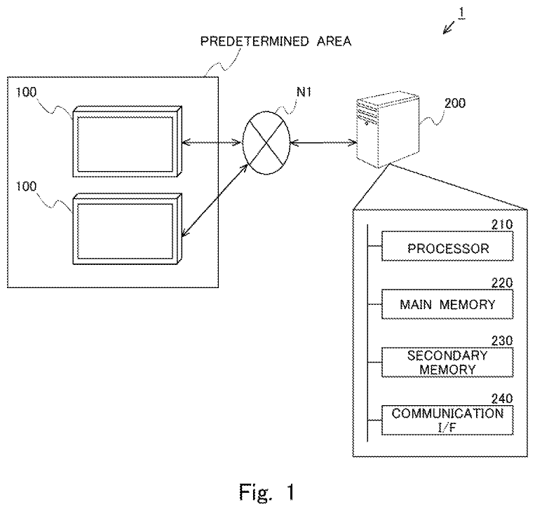

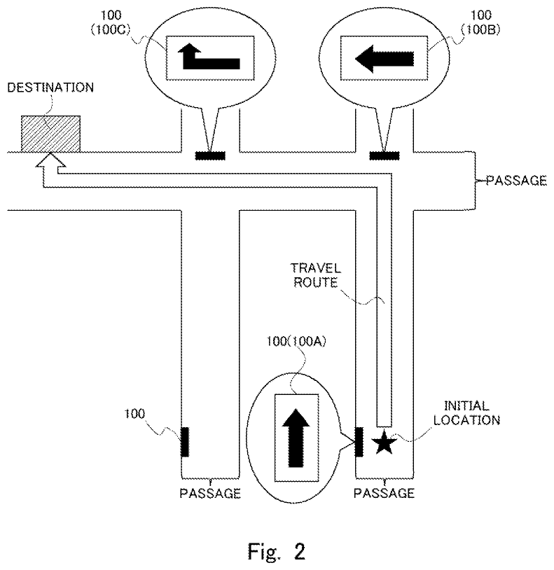

A guidance system 1 according to this embodiment will be described with reference to FIG. 1 and FIG. 2. FIG. 1 is a diagram illustrating a schematic configuration of the guidance system 1 according to this embodiment. The guidance system 1 includes a plurality of digital signs 100 and a management server 200.

Each of the digital signs 100 is a digital sign that guides a user to a destination. Each of the digital signs 100 is provided in a predetermined area. The predetermined area is, for example, an area defined by an inside of a building. FIG. 2 is a diagram illustrating a part of the predetermined area. In FIG. 2, four digital signs 100 are provided on passages. In FIG. 2, an initial location of the user is indicated with a star symbol. The initial location of the user, here, is a location where the user requests route guidance to a destination. In addition, in FIG. 2, an open arrow indicates a travel route from the initial location of the user to the destination. Furthermore, in an example illustrated in FIG. 2, three digital signs 100 (100A, 100B, and 100C) are provided on the travel route. Each of the digital signs 100A, 100B, and 100C guides the user to the destination.

In the example illustrated in FIG. 2, the digital sign 100A guides the user to the digital sign 100B. More specifically, the digital sign 100A displays an arrow that guides the user to go straight through a passage in an upward direction on a plane of paper. In addition, the digital sign 100B guides the user to the digital sign 100C. More specifically, the digital sign 100B displays an arrow that guides the user to turn left from the passage.

The user is guided by the digital sign 100A and the digital sign 100B to travel from the initial location to a location where the digital sign 100C is provided. The digital sign 100C is a digital sign 100 that lastly guides the user to the destination on the travel route. The digital sign 100C, there, guides the user to the destination. More specifically, the digital sign 100C displays an arrow (bent arrow) that indicates to the user that going straight through the passage leads to the destination found on the right side.

Thus, the digital sign 100A, the digital sign 100B, and the digital sign 100C guide the user to the destination in coordination with one another. The user travels from the initial location to the destination in accordance with guidance by the digital signs 100A, 100B, and 100C. In this case, the digital sign 100A corresponds to a “first sign” of the present disclosure. In addition, the digital sign 100B corresponds to a “second sign” of the present disclosure and the “first sign” of the present disclosure. In other words, the digital sign 100A guides the user to the digital sign 100B as the “second sign.” In addition, the digital sign 100B guides, as the “first sign,” the user to the digital sign 100C as the “second sign.” Thus, the digital sign 100B relays guidance for the user as the “second sign” and the “first sign” when the guidance system 1 guides the user to the destination. In addition, the digital sign 100C in this embodiment also corresponds to a “last sign” of the present disclosure.

The management server 200 is a server device that manages the plurality of digital signs 100 provided in the predetermined area. The management server 200 includes a computer having a processor 210, a main memory 220, a secondary memory 230, and a communication interface (communication I/F) 240. The processor 210 is, for example, a central processing unit (CPU) or a digital signal processor (DSP). The main memory 220 is, for example, a random access memory (RAM). The secondary memory 230 is, for example, a read only memory (ROM). In addition, the secondary memory 230 is, for example, a hard disk drive (HDD) or a disk recording medium such as a CD-ROM, a DVD disk, or a Blu-ray disk. Furthermore, the secondary memory 230 may be removable media (removable storage medium). Here, examples of the removal media include a USB memory and an SD card. Examples of the communication I/F 240 include a local area network (LAN) interface board or a wireless communication circuit for wireless communication.

On the management server 200, the secondary memory 230 stores an operating system (OS), various programs, and various information tables. In addition, on the management server 200, the processor 210 loads programs stored in the secondary memory 230 into the main memory 220 and executes them, thereby allowing various functions described later to be implemented. However, part or all of the functions in the management server 200 may be implemented by a hardware circuit such as ASIC or FPGA. It should be noted that the management server 200 is not necessarily required to be implemented by a single physical configuration and may be formed from a plurality of computers that cooperate with each other. Furthermore, it should be noted that the digital sign 100 also includes a computer, as with the management server 200.

In the guidance system 1, the plurality of digital signs 100 and the management server 200 are mutually connected by a network N1. As the network N1, for example, a wide area network (WAN) which is a global public communication network such as the Internet, or a telephone communication network such as for a cellular phone may be employed.

### (Functional Configuration)

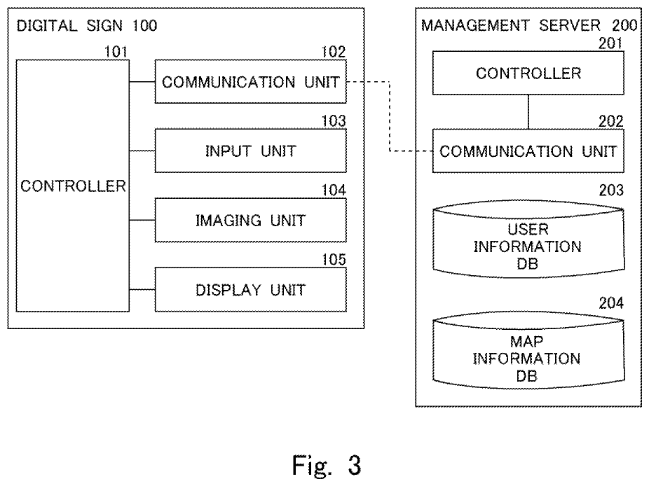

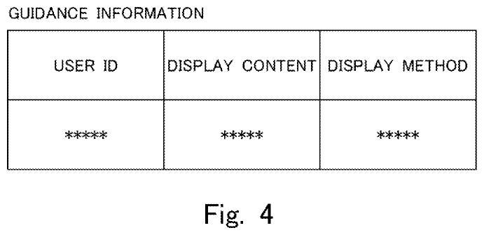

Next, description will be made with reference to FIG. 3 and FIG. 4, as to the functional configuration of each of the digital sign 100 and the management server 200. FIG. 3 is a block diagram schematically illustrating an example of the functional configuration of each of the digital sign 100 and the management server 200.

### (Management Server)

The management server 200 includes a controller 201, a communication unit 202, a user information database (user information DB) 203, and a map information database (map information DB) 204. The controller 201 has a function of performing arithmetic processing for controlling the management server 200. The controller 201 can be implemented by the processor 210 in the management server 200. In addition, the communication unit 202 has a function for connecting the management server 200 to the network N1. The communication unit 202 can be implemented by the communication I/F 240 in the management server 200.

The user information DB 203 is a database that stores user information that is information on a user. The user information DB 203 can be implemented by the secondary memory 230 in the management server 200. The controller 201 receives the user information from a digital sign 100 by the communication unit 202, and stores it. Here, the user information is information that includes both information on a display method in the digital sign 100 in guiding the user to the destination (hereinafter, may be simply referred to as a “display method”) and face information of the user. Here, the information on the display method is information on a color of an arrow that is displayed on the digital sign 100 in guiding the user to the destination. Details of the user information will be described later.

The map information DB 204 is a database that stores map information for a predetermined area. The map information also includes information on a location where each digital sign 100 is provided within the predetermined area. The map information is preliminarily stored in the map information DB 204. The map information DB 204 can be implemented by the secondary memory 230 in the management server 200. The controller 201 receives destination information on the destination of the user from a digital sign 100 which is provided in an initial location of the user. In the example illustrated in FIG. 2, the controller 201 receives the destination information from the digital sign 100A. In addition, at this time, the controller 201 identifies the initial location of the user by identifying the digital sign 100 which has transmitted the destination information. The controller 201 then determines a travel route from the initial location of the user to the destination based on the map information stored in the map information DB 204.

In addition, the controller 201 identifies digital signs 100 that exist on the travel route, based on the map information stored in the map information DB 204. In the example illustrated in FIG. 2, the digital signs 100A, 100B, and 100C within the predetermined area are identified. The controller 201 then transmits guidance information for guiding the user to the destination, to each of the identified digital signs 100A, 100B, and 100C. In this case, the controller 201 transmits guidance information for guiding the user to the digital sign 100B, to the digital sign 100A. The controller 201 also transmits guidance information for guiding the user to the digital sign 100C, to the digital sign 100B. In addition, the controller 201 transmits guidance information for guiding the user to the destination, to the digital sign 100C.

FIG. 4 is a diagram illustrating an example of a table configuration of guidance information. As illustrated by FIG. 4, the guidance information has a user ID field, a display content field, and a display method field. In the user ID field, a user ID that is an identifier for identifying a user is input. In the display content field, a display content for a digital sign 100 guiding the user corresponding to the user ID to a destination is input. In the display content field, for example, the orientation, shape, and the like of an arrow to be displayed on the digital sign 100 is input. In the display method field, display information for guiding the user corresponding to the user ID in accordance with a display method in user information is input.

The guidance information to be transmitted to the digital signs 100A and 100B in this embodiment corresponds to the “first information” of the present disclosure. In addition, the guidance information to be transmitted to the digital sign 100C in this embodiment corresponds to the “second information” of the present disclosure.

### (Digital Sign)

Each digital sign 100 includes a controller 101, a communication unit 102, an input unit 103, an imaging unit 104, and a display unit 105. The controller 101 has a function of performing arithmetic processing for controlling the digital sign 100. The controller 101 is formed from, for example, a processor in the digital sign 100. The communication unit 102 has a function of connecting the digital sign to the network N1. The communication unit 102 can be implemented by a communication I/F in the digital sign 100.

The input unit 103 has a function for inputting various information to the digital sign 100. The input unit 103 can be implemented by a touch panel on the digital sign 100. A user inputs their destination into the input unit 103. This allows the controller 101 to obtain the destination of the user. Then, the controller 101 generates destination information including the destination of the user and transmits the destination information to the management server 200 via the communication unit 102. In addition, the user selects a display method in the digital sign 100 guiding the user to the destination. Then, the user inputs the selected display method into the input unit 103. This allows the digital sign 100 to obtain the display method.

The imaging unit 104 has a function of capturing an image of surroundings of the digital sign 100. The imaging unit 104 can be implemented by a camera in the digital sign 100. The controller 101 causes the imaging unit 104 to capture an image of a face of a user when the user inputs a destination into the input unit 103. Then, the controller 101 generates face information of the user based on a face image of the user which has been captured by the imaging unit 104. Furthermore, the controller 101 transmits, to the management server 200, user information including both information on the display method which has been selected by the user and the face information of the user. In the example illustrated in FIG. 2, a user inputs a destination into the digital sign 100A that is a digital sign provided at an initial location. At this time, the digital sign 100A captures an image of the user. Then, the digital sign 100A transmits user information to the management server 200.

In addition, the controller 101 transmits in real time the image or moving image of surroundings of the digital sign 100, which has been captured by the imaging unit 104, to the management server 200. The management server 200 detects a user from the image or moving image received from the digital sign 100, based on face information of the user in user information stored in the user information DB 203. Then, the management server 200 obtains a current location of the detected user, based on the image or moving image received from the digital sign 100. In addition, the management server 200 calculates a relative location between the digital sign 100 and the user, based on the obtained current location of the user. Then, it determines a position where information for the digital sign 100 guiding the user to the destination is to be displayed (hereinafter, may be referred to as a “display position,”) based on the relative location between the digital sign 100 and the user. For example, when the user is approaching the digital sign 100 from a right side of the digital sign 100, the management server 200 determines a right side of the digital sign 100 as a display position.

The management server 200 transmits, when a user is present within a predetermined range from a digital sign 100 which has transmitted an image or moving image, display instruction information that instructs display of information for guiding the user to the destination (hereinafter, may be referred to as “guidance display”), to the digital sign. Here, the predetermined range is, for example, a range in which the user can visually recognize display on the digital sign. In addition, the display instruction information includes both information instructing the digital sign 100 to perform guidance display and information indicating a display position. When a user requests, at an initial location, route guidance to a destination, it is assumed that the user is present within a predetermined range from a digital sign 100 provided at the initial location. Therefore, the management server 200 may transmit display instruction information in transmitting guidance information without obtaining a current location of a detected user based on an image or moving image received from the digital sign 100 provided at the initial location. More specifically, in the example illustrated in FIG. 2, the management server 200 transmits display instruction information in transmitting guidance information to the digital sign 100A.

The display unit 105 has a function of displaying various information to a user. The display unit 105 can be implemented by the touch panel on the digital sign 100. The controller 101 receives guidance information from the management server 200 by the communication unit 102. In addition, the controller 101 receives display instruction information from the management server 200 by the communication unit 102. When receiving display instruction information, the controller 101 causes the display unit 105 to provide a guidance display based on the guidance information. At this time, the controller 101 causes the display unit 105 to display an arrow in accordance with a display content in the guidance information. In addition, the controller 101 causes the display unit 105 to display an arrow of a color in accordance with a display method in the guidance information. Here, a case is assumed in which the digital sign 100 receives a plurality of pieces of guidance information for guiding a plurality of users to their respective destinations from the management server 200. In this case, the controller 101 causes the display unit 105 to display a plurality of arrows based on the plurality of pieces of guidance information so as to guide the plurality of users to their respective destinations. Even in such a case, each of the arrows is displayed so as to have a color in accordance with a display method in corresponding guidance information, thereby allowing each of the plurality of users to recognize which display is directed for themselves.

In addition, the controller 101 causes a guidance display to be provided at a display position on the display unit 105, based on information indicating a display position in the display instruction information. This allows a user to easily see the guidance display in approaching the digital sign 100.

### (Information and Process Flows)

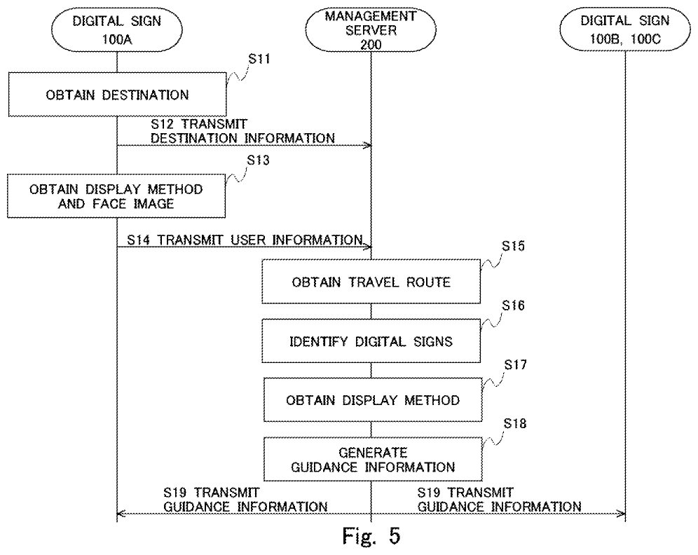

Description will be made with reference to FIG. 5, as to flows of both information between the digital signs 100 (100A, 100B, and 100C) and the management server 200 and each process in the guidance system 1. FIG. 5 is a first sequence diagram illustrating information and process flows in the guidance system 1 according to this embodiment.

In the guidance system 1, the digital sign 100A obtains a destination of a user (S11). Here, the destination is obtained by the user inputting their destination into the digital sign 100A. Then, the digital sign 100A transmits destination information to the management server 200 (S12). Next, the digital sign 100A obtains a display method and a face image of the user (S13). Here, the display method is obtained by the user inputting the display method into the digital sign 100A. In addition, the face image of the user is obtained by the digital sign 100A capturing an image of a face of the user. Then, the digital sign 100A transmits user information to the management server 200 (S14).

The management server 200 obtains a travel route based on the destination information (S15). Here, the management server 200 determines a travel route based on map information stored in the map information DB 204, and obtains the determined travel route. Then, the management server 200 identifies digital signs 100 (100A, 100B, and 100C) that exist on the obtained travel route (S16). Next, the management server 200 obtains information on a display method included in the user information stored in the user information DB 203 (S17). The management server 200 generates guidance information that is to be transmitted to each of the identified digital signs 100 (S18). At this time, the management server 200 generates, based on the obtained information on a display method, guidance information into which display information for guiding the user in accordance with the display method is incorporated. Then, the management server 200 transmits the guidance information to each of the identified digital signs 100 (100A, 100B, and 100C) (S19).

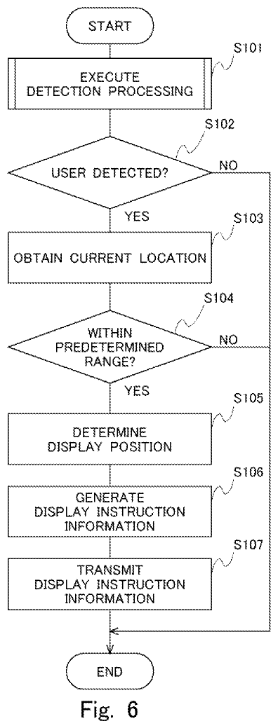

Next, description will be made with reference to FIG. 6 as to display instruction processing executed by the controller 201 in the management server 200 in the guidance system 1 according to this embodiment. FIG. 6 is a flowchart of the display instruction processing. The display instruction processing is processing of transmitting display instruction information to a digital sign 100 when a user is present within a predetermined range from the digital sign 100. The display instruction processing is periodically executed at a predetermined interval.

In the display instruction processing, first at S101, detection processing is executed by using an image or moving image received from a digital sign 100 (100A) provided at an initial location. Here, in the detection processing, the controller 201 detects a user from the image or moving image, based on face information of the user which is included in user information stored in the user information DB 203. As a method of detecting a user from an image or moving image in the detection processing, a publicly known method may be employed. Next, at S102, it is determined whether a user has been detected from the image or moving image. If a negative determination is made at S102, the display instruction processing ends. If an affirmative determination is made at S102, a current location of a detected user is obtained at S103. Then, at S104, it is determined whether the user is present within a predetermined range from the digital sign 100 that has transmitted the image or moving image, based on the current location of the user. If a negative determination is made at S104, the display instruction processing ends. If an affirmative determination is made at S104, a display position is determined based on a relative location between the digital sign 100 and the user at S105. Then, at S106, display instruction information is generated. Here, the display instruction information is information that includes the display position determined at S105. At S107, the display instruction information is transmitted to the digital sign 100. Then, the display instruction processing ends. The digital sign 100 having received the display instruction information provides a guidance display based on the guidance information and display instruction information which have been received from the management server 200.

As described above, the management server 200 in the guidance system 1 transmits guidance information to a plurality of digital signs 100 that exist on a travel route of a user. Then, each of the digital signs 100 guides the user to a destination. Thus, the guidance system 1 allows the user to be guided to the destination.

### (Modification)

In this embodiment, each digital sign 100 displays an arrow so as to guide a user to a destination. However, the digital sign 100 does not necessarily need to use an arrow so as to guide a user to a destination. The digital sign 100 may perform guidance by displaying a moving image of a character pointing a destination, for example. Furthermore, a character to be displayed on the digital sign 100 may be selected by a user themselves. In this case, information on a display method included in user information is information about the character selected by the user.

In addition, in this embodiment, the management server 200 determines a travel route from an initial location of a user to a destination. However, the travel route does not necessarily need to be determined by the management server 200. For example, the management server 200 may obtain a travel route from an initial position of a user to a destination from a server device that manages map information for a predetermined area.

Furthermore, in this embodiment, each digital sign 100 provides a guidance display when receiving display instruction information from the management server 200. However, the digital sign 100 may provide a guidance display when receiving guidance information from the management server 200. In this case, when determining that a user is present within a predetermined range from a digital sign 100, the management server 200 transmits guidance information to the digital sign 100. In addition, in this case, the guidance information includes information indicating a display position.

### <Second Embodiment>

In the first embodiment, a user inputs a destination and a display method to a digital sign 100 (100A). In response to this, the digital sign 100 obtains destination information and user information and transmits them to the management server 200. In contrast, in this embodiment, the management server 200 receives destination information and user information from a user terminal associated with a user. The following will describe only the differences with respect to the first embodiment.

### (System Overview)

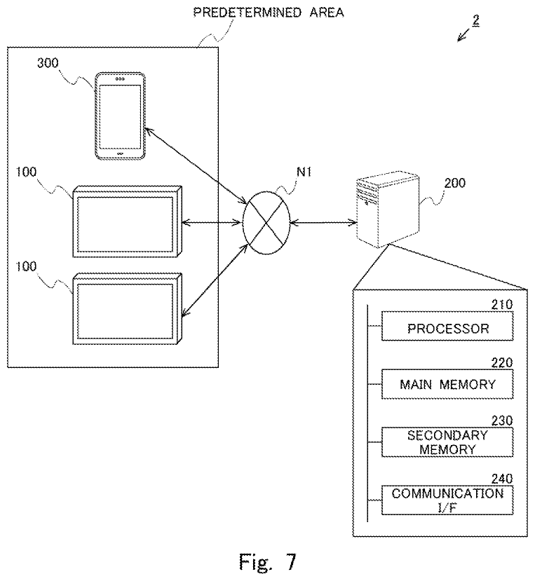

A guidance system 2 according to this embodiment will be described with reference to FIG. 7. FIG. 7 is a diagram illustrating a schematic configuration of the guidance system 2 according to this embodiment. The guidance system 2 includes a plurality of digital signs 100, a management server 200, and a user terminal 300. Here, the user terminal 300 is a terminal associated with a user. Examples of the user terminal 300 may include a computer and a mobile information terminal which are used by the user.

### (Functional Configuration)

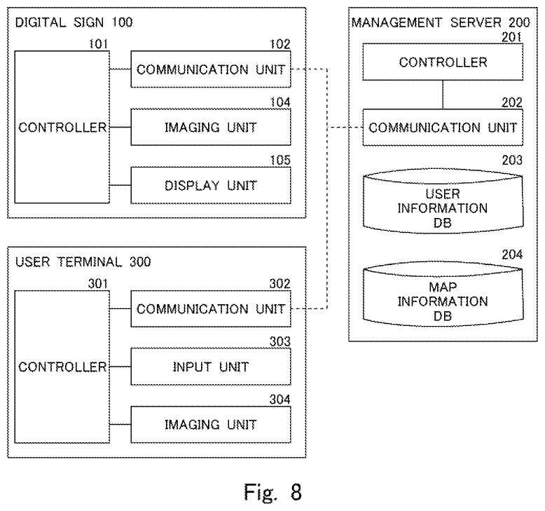

Next, description will be made with reference to FIG. 8, as to the functional configuration of each of a digital sign 100, the management server 200, and the user terminal 300 which are included in the guidance system 2 according to this embodiment. FIG. 8 is a block diagram schematically illustrating an example of the functional configuration of each of the digital sign 100, the management server 200, and the user terminal 300.

### (User Terminal)

The user terminal 300 includes a controller 301, a communication unit 302, an input unit 303, and an imaging unit 304. The controller 301 has a function of performing arithmetic processing for controlling the user terminal 300. The controller 301 can be implemented by a processor in the user terminal 300. The communication unit 302 has a function for connecting the user terminal 300 to the network N1.

The communication unit 302 has a function of connecting the user terminal 300 to the network N1. The communication unit 302 can be implemented by a communication I/F in the user terminal 300. The input unit 303 has a function for inputting various information to the user terminal 300. The input unit 303 can be implemented by a touch panel on the user terminal 300. The user inputs their destination into the input unit 303. This allows the controller 301 to obtain the destination of the user. In addition, the user inputs, for example, an identifier of a digital sign 100 provided at an initial location. Thus, the controller 301 obtains the initial location of the user. Then, the controller 301 generates destination information including the destination and initial location of the user and transmits it to the management server 200 via the communication unit 302. This allows the management server 200 to grasp the destination and initial location of the user. In addition, the user selects a display method and inputs the selected display method into the input unit 303. This allows the controller 301 to obtain the display method.

The imaging unit 304 has a function of capturing an image of a user's face. The imaging unit 304 can be implemented by a camera in the user terminal 300. The controller 301 generates face information of a user based on a face image of the user which has been captured by the imaging unit 304. The controller 301 transmits user information including a display method to the management server 200 via the communication unit 302. The controller 301 transmits, to the management server 200, user information including both information on a display method which has been selected by the user and face information of the user. The management server 200 stores the user information in the user information DB 203.

### (Information and Process Flows)

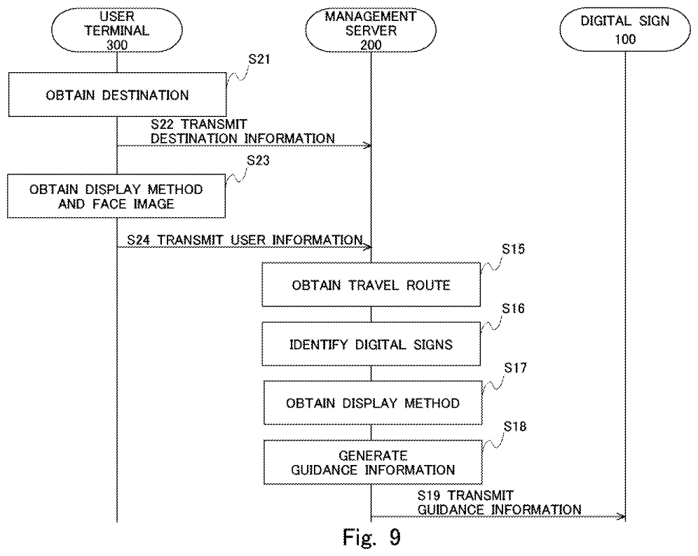

Description will be made with reference to FIG. 9, as to flows of both information between a digital sign 100, the management server 200, and the user terminal 300, and each process in the guidance system 2. FIG. 9 is a second sequence diagram illustrating information and process flows in the guidance system 2 according to this embodiment.

In the guidance system 2, the user terminal 300 obtains a destination and an initial location of a user (S21). Here, the destination and initial location are obtained by the user inputting their destination and an identifier of a digital sign 100 provided at the initial location. Then, the user terminal 300 transmits destination information to the management server 200 (S22). The user terminal 300 obtains a display method and a face image of the user (S23). Here, the display method is obtained by the user inputting the display method into the user terminal 300. In addition, the face image of the user is obtained by the user terminal 300 capturing an image of a face of the user. Then, the user terminal 300 transmits user information to the management server 200.

The management server 200 obtains a travel route based on the destination information and identifies a plurality of digital signs 100 (S15 and S16), as with the first embodiment. Next, the management server 200 obtains the display method from the user information DB (S17). Then, the management server 200 generates guidance information that is to be transmitted to each of the identified digital signs 100 and transmits it (S18 and S19).

Also in this embodiment, the management server 200 in the guidance system 2 executes display instruction processing. Since details of display processing are the same as those in the first embodiment, description thereof will be omitted.

As described above, the management server 200 in the guidance system 2 transmits guidance information to a plurality of digital signs 100 on a travel route of a user. Thus, the guidance system 2 allows the user to be guided to a destination.

### (Modification)

In this embodiment, the management server 200 obtains a current location of a user, based on the image or moving image of surroundings of a digital sign 100 which is transmitted by the digital sign 100. However, as a method of the management server 200 obtaining a current location of a user, a publicly known method can be employed. For example, a digital sign 100 may obtain a current location of a user through communication between the digital sign 100 and a user terminal 300 using a predetermined short-range wireless communication standard. Here, examples of the predetermined short-range wireless communication standard may include Bluetooth (registered trademark) LowEnergy standard or WiFi (registered trademark), and the like. Then, information on the current location of the user, which has been obtained by the digital sign 100, may be transmitted to the management server 200. This arrangement also allows the management server 200 to transmit display instruction information.

### <Other Embodiments>

The above embodiments are merely examples, and the present disclosure can be appropriately modified and implemented without departing from the spirit thereof. In addition, the processing and means described in the present disclosure can be implemented in any combination as long as no technical contradiction occurs.

In addition, the processing described as being performed by one device may be shared and executed by a plurality of devices. Alternatively, the processing described as being performed by different devices may be executed by one device. In a computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer readable storage media include any type of disk such as a magnetic disk (floppy (registered trademark) disk, hard disk drive (HDD), etc.), and an optical disk (CD-ROM, DVD disk, Blu-ray disk, etc.), a read-only memory (ROM), a random access memory (RAM), an EPROM, an EEPROM, a magnetic card, a flash memory, an optical card, or any type of medium suitable for storing electronic instructions.

What is claimed is:

1. An information processing device, comprising:
a controller comprising at least one processor configured to execute:
obtaining a travel route to a destination of a user;
identifying a plurality of digital signs existing on the travel route, the digital signs guiding the user to the destination; and
transmitting first information to a first sign included in the plurality of digital signs, the first information being information for guiding the user to a second sign, the second sign being a digital sign guiding the user to the destination subsequently to the first sign on the travel route.

2. The information processing device according to claim 1, wherein
the controller further executes transmitting second information to a last sign out of the plurality of digital signs, the second information being information for guiding the user to the destination, the last sign being a digital sign lastly guiding the user to the destination on the travel route.

3. The information processing device according to claim 1, wherein
the controller further executes:
obtaining a display method in the plurality of digital signs guiding the user to the destination; and
transmitting display information to the plurality of digital signs, the display information being for guiding the user in accordance with the display method.

4. The information processing device according to claim 1, wherein
the controller further executes:
obtaining a current location of the user; and
causing one of the plurality of digital signs to display information for guiding the user to the destination, the one of the plurality of digital signs being such that the user is present within a predetermined range therefrom.

5. The information processing device according to claim 4, wherein
the controller determines a position for displaying information on a display unit of one of the plurality of digital signs, the information being for guiding the user to the destination, the one of the plurality of digital signs being such that the user is present within a predetermined range therefrom, the determining being performed based on a relative location between the one of the plurality of digital signs and the user.

6. The information processing device according to claim 1, wherein
the controller receives information including an initial location and the destination from a terminal associated with the user, the initial location being where the user requests route guidance to the destination.

7. The information processing device according to claim 1, wherein
the controller receives information including the destination from one of the plurality of digital signs, the one of the plurality of digital signs being provided at an initial location where the user requests route guidance to the destination.

8. An information processing method executed by a computer, comprising:
obtaining a travel route to a destination of a user;
identifying a plurality of digital signs existing on the travel route, the digital signs guiding the user to the destination; and
transmitting first information to a first sign included in the plurality of digital signs, the first information being information for guiding the user to a second sign, the second sign being a digital sign guiding the user to the destination subsequently to the first sign on the travel route.

9. The information processing method according to claim 8, further comprising transmitting second information to a last sign out of the plurality of digital signs, the second information being information for guiding the user to the destination, the last sign being a digital sign lastly guiding the user to the destination on the travel route.

10. The information processing method according to claim 8, further comprising:
obtaining a display method in the plurality of digital signs guiding the user to the destination; and
transmitting display information to the plurality of digital signs, the display information being for guiding the user in accordance with the display method.

11. The information processing method according to claim 8, further comprising:
obtaining a current location of the user; and
causing one of the plurality of digital signs to display information for guiding the user to the destination, the one of the plurality of digital signs being such that the user is present within a predetermined range therefrom.

12. The information processing method according to claim 11, wherein
a position for displaying information on a display unit of one of the plurality of digital signs is determined based on a relative location between the one of the plurality of digital signs and the user, the information being for guiding the user to the destination, the one of the digital signs being such that the user is present within a predetermined range therefrom.

13. The information processing method according to claim 8, wherein
information including an initial location and the destination is received from a terminal associated with the user, the initial location being where the user requests route guidance to the destination.

14. The information processing method according to claim 8, wherein
information including the destination is received from one of the plurality of digital signs, the one of the plurality of digital signs being provided at an initial location where the user requests route guidance to the destination.

15. A system, comprising:
an information processing device and a plurality of digital signs, wherein
the information processing device performs:
obtaining a travel route to a destination of a user;
identifying a plurality of digital signs existing on the travel route, the digital signs guiding the user to the destination; and
generating first information for a first sign included in the plurality of digital signs, the first information being information for guiding the user to a second sign, the second sign being a digital sign guiding the user to the destination subsequently to the first sign on the travel route; and
the plurality of digital signs receive the first information from the information processing device.

16. The system according to claim 15, wherein
the information processing device generates second information for a last sign out of the plurality of digital signs, the second information being information for guiding the user to the destination, the last sign being a digital sign lastly guiding the user to the destination on the travel route; and
the last sign receives the second information from the information processing device.

17. The system according to claim 15, wherein
the information processing device performs:
obtaining a display method in the plurality of digital signs guiding the user to the destination; and
generating display information for guiding the user in accordance with the display method; and
the plurality of digital signs receive the display information from the information processing device.

18. The system according to claim 15, wherein
each of the plurality of digital signs displays information when the user is present within a predetermined range, the information being for guiding the user to the destination.

19. The system according to claim 18, wherein
a position for displaying information on a display unit of one of the plurality of digital signs is determined based on a relative location between the one of the plurality of digital signs and the user, the information being for guiding the user to the destination, the one of the plurality of digital signs being such that the user is present within a predetermined range therefrom.

20. The system according to claim 15, further comprising:
a terminal associated with the user; wherein
the information processing device receives information including an initial location and the destination from the terminal, the initial location being where the user requests route guidance to the destination.
